(19) United States
(12) Patent Application Publication
(10) Pub. No.: US 2021/0240466 A1
(43) Pub. Date: Aug. 5, 2021

(54) SELF-SERVICE TERMINAL

(71) Applicant: ELO TOUCH SOLUTIONS, INC., Milpitas, CA (US)

(72) Inventors: Yin SUN, SHANGHAI (CN); Haolai ZHOU, SHANGHAI (CN); Hua SHAO, SHANGHAI (CN)

(21) Appl. No.: 17/259,776

(22) PCT Filed: Aug. 7, 2020
(86) PCT No.: PCT/US2020/045488

§ 371 Date: Jan. 12, 2021

(30) Foreign Application Priority Data
Aug. 14, 2019 (CN) 201910748424.9

(51) Int. Cl. G06F 8/65; G06Q 20/18; G06F 16/14; G06F 8/71

(52) U.S. Cl. CPC G06F 8/65; G06F 8/71; G06F 16/148; G06Q 20/18

(57) ABSTRACT

The present disclosure relates to a self-service terminal comprising an application module, a management module and one or more devices which facilitates automatic operation and maintenance of the self-service terminal. The application module is configured to compare a target file for at least one device of the one or more devices to update with a current file that is being used by the at least one device, determine if the current file is different from the target file, and update the current file in response to that it is determined that the current file is different from the target file.

The present application a national stage application, filed under 35 U.S.C. § 371, of International Application No. PCT/US2020/045488, filed on Aug. 7, 2020, which claims priority to Chinese Patent Application No. 201910748424.9, filed on Aug. 14, 2019, both of which are incorporated herein by reference in their entireties.

### TECHNICAL FIELD

The present disclosure relates to the field of self-service technology, and in particular to a self-service terminal.

### BACKGROUND

A self-service, such as for example self-purchase, self-order, self-checkout, business self-handling, typically uses a self-service terminal.

FIG. 1 shows a block diagram of a self-service system 100. The self-service system 100 includes a control center 110 and a plurality of self-service terminals 151 through 156, 161 through 166 and the like. The self-service terminals 151, 152 (may be more) may be disposed in a store 131 (e.g., a supermarket, a bank, etc.), and the self-service terminals 153, 154 may be disposed in a store 132, the self-service terminal 155, 156 may be disposed in a store 133. The stores 131 through 133 (may be more) may be located in an area 121 (e.g., a city). The self-service terminals 161 through 166 and the like (not shown) may be disposed in stores 141 through 143 that are located in an area 122. Each of the self-service terminals 151 through 156, 161 through 166 and the like in each of the areas 121 and 122 may be communicably connected to the control center 110 (shown in FIG. 1 with a solid lines that are connected between the areas 121, 122 and the control center 110).

In the above, blocks 131 through 133, 141 through 143 and the like are described to represent stores, and blocks 121, 122 and the like are described to represent areas. However, it will be appreciated that any of the blocks 131 through 133, 141 through 143, 121 and 122 may also represent an open area (e.g., a square, a park, etc.) where the corresponding self-service terminals are disposed, a manufacturer of the service terminal (since self-service terminals manufactured by different manufacturers may have different rules for control, operation and maintenance), an operator of the service terminal (since self-service terminals operated by different operators may require different configurations) or the like.

### SUMMARY

One of aims of the present disclosure is to provide a self-service terminal.

An aspect of this disclosure is to provide a self-service terminal. The self-service terminal may comprise: one or more devices; an application module configured to provide an application to a user; and a management module configured to manage the one or more devices, wherein the application module is further configured to: compare a target file for at least one device of the one or more devices to update with a current file that is being used by the at least one device, determine if the current file is different from the target file, and send the target file to the management module in response to that it is determined that the current file is different from the target file, wherein the target file comprises a configuration file or a program file that is capable of being used by the at least one device; the management module is further configured to: receive the target file from the application module, and send the target file to the at least one device; and the at least one device is configured to: receive the target file and update the current file to the target file.

Further features of the present disclosure and advantages thereof will become apparent from the following detailed description of exemplary embodiments with reference to the attached drawings.

### BRIEF DESCRIPTION OF THE DRAWINGS

The accompanying drawings, which constitute a part of the specification, illustrate embodiments of the present disclosure and, together with the description, serve to explain the principles of the present disclosure.

The present disclosure will be better understood according the following detailed description with reference of the accompanying drawings.

FIG. 1 is a block diagram schematically illustrating a self-service system to which self-service terminals according to embodiments of the present disclosure may be applied.

FIG. 2 is a block diagram schematically illustrating a self-service terminal according to embodiments of the present disclosure and connections to a control center.

FIG. 3 is a block diagram schematically illustrating a management module in a self-service terminal according to embodiments of the present disclosure.

FIG. 4 is a flow chart of information schematically illustrating an operating method of a self-service terminal according to embodiments of the present disclosure.

FIG. 5 is a block diagram schematically illustrating at least a portion of a self-service terminal according to embodiments of the present disclosure.

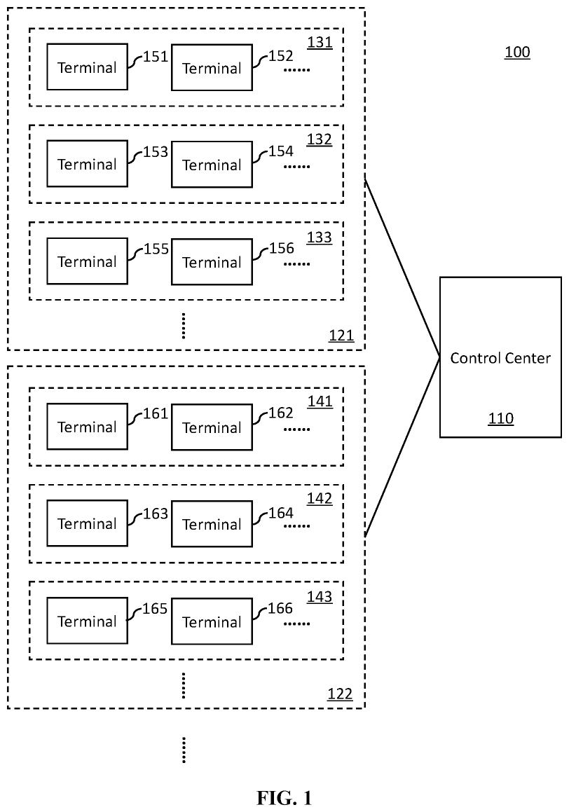

Note that, in the embodiments described below, in some cases the same portions or portions having similar functions are denoted by the same reference numerals in different drawings, and description of such portions is not repeated. In some cases, similar reference numerals and letters are used to refer to similar items, and thus once an item is defined in one figure, it need not be further discussed for following figures.

### DETAILED DESCRIPTION

Various exemplary embodiments of the present disclosure will be described in details with reference to the accompanying drawings in the following. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit this disclosure, its application, or uses. It should be understood by those skilled in the art that, these examples, while indicating the implementations of the present disclosure, are given by way of illustration only, but not in an exhaustive way.

The term “A or B” used through the specification refers to “A and B” and “A or B” rather than meaning that A and B are exclusive, unless otherwise specified.

The term “exemplary”, as used herein, means “serving as an example, instance, or illustration”, rather than as a “model” that would be exactly duplicated. Any implementation described herein as exemplary is not necessarily to be construed as preferred or advantageous over other implementations. Furthermore, there is no intention to be bound by any expressed or implied theory presented in the preceding technical field, background, summary or detailed description.

In addition, certain terminology, such as the terms “first”, “second” and the like, may also be used in the following description for the purpose of reference only, and thus are not intended to be limiting. For example, the terms “first”, “second” and other such numerical terms referring to structures or elements do not imply a sequence or order unless clearly indicated by the context.

Further, it should be noted that, the terms “comprise”, “include”, “have” and any other variants, as used herein, specify the presence of stated features, integers, steps, operations, elements, and/or components, but do not preclude the presence or addition of one or more other features, integers, steps, operations, elements, components, and/or groups thereof.

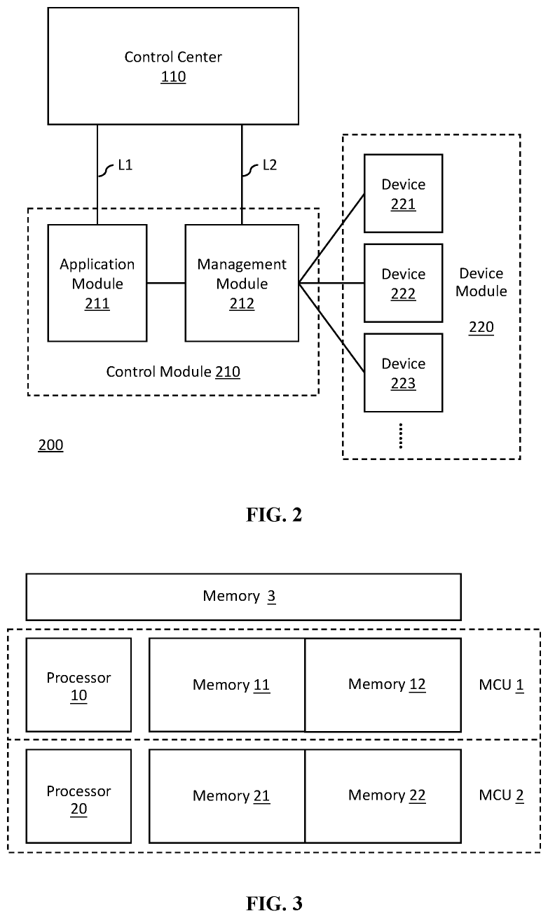

FIG. 2 is a block diagram schematically illustrating a self-service terminal 200 according to embodiments of the present disclosure and connections to a control center 110. The self-service terminal 200 may be, for example, a self-service vending machine, a self-service ticket-vending machine, a self-service ordering machine, a self-checkout machine, a self-service check-in machine, a self-service registering machine, a self-service paying machine, a kiosk, and/or the like. The self-service terminal 200 includes a control module 210 and a device module 220. The control module 210 is configured to control operations of the self-service terminal 200. In some embodiments, the control module 210 may comprise an application module 211 and a management module 212. The application module 211 is configured to provide an application to a user, and the management module 212 is configured to manage the device module 220. However, it will be appreciated that in some other embodiments, the control module 210 may not be divided into the application module 211 and the management module 212 from the perspective of either software or hardware, and control operations of the self-service terminal 200 as a whole.

The device module 220 may include a plurality of devices 221 through 223. One or more of the plurality of devices 221 through 223 may be input/output devices for the self-service terminal 200. For example, a device in the device module 220 may be a printer, a scanner, a graphic code reader, a shopping bag machine, a camera, a point of selling (POS) machine, a credit card reader, an electrical/magnetic tag detector, a degaussing device, an ID card reader, a fingerprint reader, a multimedia player, an indicator/decorative light, a power controller, a fan, a keyboard, a touch button, a touch panel, a display, a thermometer, a hygrometer, a GPS positioning device or the like. When referring to the device module 220 herein, in accordance with the context, it may refer to all of the devices 221 through 223, or may refer to one or more of the devices 221 through 223. In the depicted embodiment, the device module 220 includes three devices 221 through 223. It will be appreciated that in other embodiments, the device module 220 may include fewer or more devices.

The application module 211 may provide an application to a user. For example, the user may be a consumer, and the application module 211 may provide the user an application or a human-machine interface for self-service (e.g., self-purchase, self-order, self-checkout, self-service business handling, or the like). It will be appreciated that the application module 211 may not provide an application or a human-machine interface directly to the user, but only provide a data interface for such an application or human-machine interface. For example, the application module 211 may provide a data interface to an application installed on a device other than the self-service terminal 200 (e.g., a smartphone) so that the user may perform self-service or operate the self-service terminal 200 via the application installed on the device. For another example, the user may be a supervisor (e.g., operation personnel, maintenance personnel, technical personnel, etc.), and the application module 211 may provide the user an application or a human-machine interface for managing or maintaining the self-service terminal 200, or provide a data interface for such an application or human-machine interface.

Communication connections may be established between the management module 212 and the application module 211, and between the management module 212 and the device module 220 through various wired or wireless communication interfaces, including but not limited to a USB interface, a COM interface, a UART interface, a GPIO interface, an SPI interface, an I2C interface, a Bluetooth interface and so on.

The operating method of the self-service terminal and the self-service terminal according to embodiments of the present disclosure will be described below based on examples of specific operations.

Operation 1: The self-service terminal 200 updates a configuration file or a program file of at least one device in the device module 220.

The control center 110 may push, to any one of self-service terminals that are communicatively connected thereto, a target file (e.g., a configuration file or a program file) for at least one device in the device module to update. The self-service terminal may receive the target file and compare it with the current file being used by the at least one device. If it is determined that the current file is different with the target file, the self-service terminal may update the current file to the target file. An exemplary scenario may be that the control center 110 pushes a program file for at least one device of the self-service terminal to update its firmware. In this way, the self-service terminal 200 that is communicatively connected to the control center 110 may update the program files and configuration files of devices thereof, even if there is no supervisor on site. An implementation of Operation 1 will be described below with reference to FIG. 4.

The control center 110 stores a target file for at least one device of the self-service terminal 200 to update into a specific storage path (S11). The specific storage path is a storage path that is pre-agreed between the control center 110 and the self-service terminal 200. The storage path may be located in a memory/storage device in the control center 110, or may be located in any other network node that the self-service terminal 200 may access. In some embodiments, a plurality of storage paths are pre-agreed between the control center 110 and the self-service terminal 200, and these storage paths respectively correspond to a plurality of respective devices included in the self-service terminal 200.

The application module 211 periodically looks up these storage paths in turn to find out whether the control center 110 has pushed a target file for updating to the self-service terminal 200 (S12). If it is found that there is a target file for updating in a specific storage path, the device which the target file is for is determined according to the storage path where the target file is stored (S13).

Then the target file may be compared with the current file that is being used by the device that the target file is for so as to determine whether the current file is different from the target file. The application module 211 may send a first query to the management module 212 so as to acquire a version identification of the current file (S14-1). The management module 212 may transform the first query into a second query whose command format is recognizable by the device and send the second query to the device so as to acquire the version identification of the current file (S14-2). After receiving the second query, the device may report the version identification of the current file to the management module 212 (S15-1), and the management module 212 sends the version identification of the current file to the application module 211 (S15-2). The application module 211 may: acquire the version identification of the target file according to a file name of the target file (for example, if the file name of the target file is pre-agreed to include its version identification); acquire the version identification of the target file according to a specific portion of the target file (for example, if a specific portion (e.g., some specific bytes) of the target file is pre-agreed to include its version identification); and/or acquire the version identification of the target file according to a received message that is associated with the target file. The application module 211 compares the version identification of the target file with the version identification of the current file (S16). If the two versions are different, it is determined that the current file is different with the target file.

In the case where it is determined that the current file is different with the target file, the application module 211 may send the target file to the management module 212 (S17-1). For example, the application module 211 splits the target file into smaller packages, and then sequentially sends the packets to the management module 212 through messages from the application module 211 to the management module 212. The management module 212 receives the target file and sends it to the device which the target file is for (S17-2). For example, the management module 212 may send a package above-mentioned, each time the package is received by the management module 212, to the device in a format agreed between the management module 212 and the device. Alternatively, after receiving all the packets of the target file from the application module 211, the management module 212 may split the target file into multiple packets (the split rule may be different from the rule of split that is performed by the application module 211), and then the packets are carried in messages that are sent from the management module 212 to the device such that the target file is sent to the device.

After receiving the target file, the device updates the current file that is being used to the target file (S18). For example, the device may be a printer, the target file may be a program file. The printer may replace the current program file that is being used with the target program file so as to update the firmware of the printer. The version of the target file may be newer or older than the version of the current file. Before updating the file, the device may verify the target file according to the verification information of the target file, and update the file if the verification is successful. For example, the target file may be verified by a CRC check based on one or more specific bytes of the file to determine if the target file is complete or corrupted. For another example, the target file may be verified to determine if the target file meets the requirements of the device (e.g., matches with the brand or type of the device) and so on. If the verification is successful, the update is performed; and if not, the update failure may be reported to the management module 212. The management module 212 may further report the update failure to the application module 211, and the application module 211 may report the update failure to the control center 110, so that the control center 110 may know about the failure or may re-push the target file for updating.

A possible implementation of Operation 1 is described above. Those skilled in the art will appreciate that other implementations may be feasible.

In other implementations, the control center 110 may push the target file for updating to the self-service terminal 200 without storing the target file in a specific (pre-agreed) storage path, for example by using one or more messages that are associated with the target file. For example, the control center 110 may first send a message to the self-service terminal 200 to indicate a storage path of the target file to allow the self-service terminal 200 to acquire the target file from the storage path. For another example, the control center 110 may first send a message to the self-service terminal 200 to indicate that the target file for updating is to be sent in following one or more messages, and then send the target file to the self-service terminal 200 by the following one or more messages. In addition, the version identification of the target file may be indicated in any of the one or more messages that are associated with the target file sent by the control center 110 to the self-service terminal 200, so that the self-service terminal 200 may acquire the version identification of the target file based on the message.

In other implementations, the self-service terminal 200 may determine the device in the device module 220 that is the target file for not according to the storage path of the target file. For example, the self-service terminal 200 may determine the device that the target file is for according to the file name of the target file, a specific portion (e.g., one or more specific bytes) in the target file, or a received message associated with the target file.

In other implementations, the self-service terminal 200 may acquire the version identification of the current file not by enquiring the corresponding device. For example, the self-service terminal 200 may read the version identification of the current file from a log file.

In other implementations, the verification on the target file may be performed by other entities, such as the application module 211 and/or the management module 212. The application module 211 may verify (or “check”) the target file according to the verification information of the target file. If the verification succeeds, the application module 211 may send the target file to the management module 212. If the verification fails, the application module 211 may directly report an update failure to the control center 110 without sending the target file to the management module 212. The verification performed by the application module 211 may be used to check the completeness of the target file (e.g., whether it is corrupted), or may be used to check the applicability of the target file (e.g., whether it is applicable to the device that the target file is for). For example, the application module 211 may acquire the applicable device information that is carried by the target file (for example, through the file name of the target file or a specific portion of the target file), and compare it with the device that the target file is for. If the applicable device does not match with the device that the target file is for, then the application module 211 may determine that the verification fails. Examples of such verification failures are that, the target file is applicable to a scanner, but the device that the target file is for determined according to the above approach is a printer; or the geographical location or IP address of the self-service terminal indicated by the target file does not match with the actual geographical location or actual IP address of the self-service terminal. Those skilled in the art will appreciate that, in other implementations, the above verifications performed by the application module 211 may be performed by the management module 212. If the verification succeeds, the target file is sent to the device; and if the verification fails, the management module 212 may report an update failure to the application module 211 without sending the target file to the device.

In addition, in other implementations, updating on a configuration of a device may be not based on a configuration file. For example, the application module 211 receives a first configuration command from the control center 110 for configuring at least one device in the device module 220 and sends the first configuration command to the management module 212. The management module 212 transforms the first configuration command into a second configuration command having a format recognizable by the at least one device, and sends the second configuration command to the at least one device. The at least one device receives the second configuration command and updates its corresponding configuration according to the second configuration command. For example, a printer (for example, for printing shopping receipts, payment receipts, etc.) installed on the self-service terminal 200 has a default printing width when the self-service terminal 200 is supplied to a merchant. However, for different merchants, even different stores of the same merchant, the printing widths of the printers of different self-service terminals may be configured to be different. According to embodiments of the present disclosure, operators of these self-service terminals may send a specific configuration command (or a configuration file as described above) to a specific self-service terminal through the control center, so as to change a configuration of any device of a self-service terminal. The content that the device may be configured may include, for example, the printing width/thickness of the printer, the printing language (e.g., Chinese, English, etc.), whether graphics printing being supported, the object which the scanner is for (e.g., barcode, QR code, etc.), the carrier of the object which the scanner is for (e.g., electronic screen, paper, etc.), the size of the shopping bag of the shopping bag machine, the color, duration of the flashing, or effect of breathing of the indicator/decorative light and the like.

The above Operation 1 may be performed at multiple timings, for example, after the self-service terminal 200 is powered on; when the self-service terminal 200 is idle; and after receiving a message from the control center 110 for indicating the self-service terminal 200 to process the target file.

Operation 2: The self-service terminal 200 updates the program file of the control module 210 or of the management module 212 in the control module 210.

In the case where the control module 210 is divided into the application module 211 and the management module 212, the Operation 2 may include: the application module 211 acquiring (according to any of the approaches described in the Operation 1) the program file from the control center 110 for updating the management module 212 and sending the program file to the management module 212. Before the sending, the application module 211 may perform, as described in the Operation 1, the verification of the file, and may compare whether the received program file is different with the program file being used by the management module 212. The management module 212 updates its program file after receiving the program file. In the case where the control module 210 is not divided into the application module 211 and the management module 212 but operates as a whole, the control module 210 acquires a program file for updating from the control center 110, and performs a verification and/or compares file versions, and updates if the verification succeeds and/or the files versions are different.

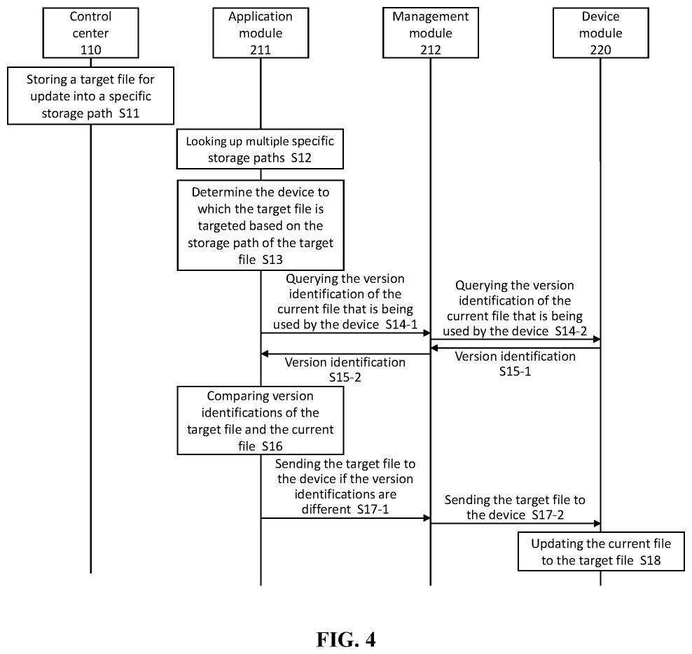

The updating process will be described below with reference to FIG. 3. In the case where the control module 210 is divided into the application module 211 and the management module 212, FIG. 3 may represent the structure of the management module 212. The management module 212 includes two processors 10 and 20, and five memories 11, 12, 21, 22 and 3. One possible implementation of the management module 212 is shown in FIG. 3, i.e., implemented by two MCUs, wherein the MCU 1 includes the processor 10 and the memories 11, 12, the MCU 2 includes the processor 20 and the memories 21, 22, and the memory 3 may be accessed by the two MCUs. It will be appreciated that the management module 212 may be implemented not by any MCU. The memories 11, 12, 21, 22 may be a non-volatile memory, such as a flash memory, and the memory 3 may be a volatile or non-volatile memory. In the case where the control module 210 is not divided into the application module 211 and the management module 212 but operates as a whole, FIG. 3 may represent the structure of the control module 210 and will not be described duplicated. The structure of the management module 212 shown in FIG. 3 will be described below as an example.

The memory 11 is configured to store a program file executed by the processor 10, and the memory 21 is configured to store a program file executed by the processor 20. For example, the MCU 1 in the two MCUs may serve as a primary MCU, and the MCU 2 may serve as a standby MCU. For example, the memory 11 may store the program file being used by the management module 212 before updating. The program file for update received by the management module 212 is stored in the memory 3. The processor 10 may copy the program file for updating stored in the memory 3 from the memory 3 to the memory 12. If the copy is successful, the processor 10 copies the program file for updating from the memory 12 to the memory 11 so as to update the program file being used in the memory 11 to the program file for updating. The updating process of the management module 212 is thus completed, and the update success may be reported to the application module 211 and further to the control center 110. The processor 10 further copies the program file in the memory 11 or 12 (that is, the program file that have been received for updating, and the program file that is being used after the update is successful) to the memory 21 so that the versions of the program files used in the two MCUs are identical. Thus, when the MCU 1 is resting and the MCU 2 is working, the management module 212 may still run the updated program file. It will be appreciated by those skilled in the art that the processor 10 may copy the program file from the memory 3 to the memory 21, but since the memory 3 may be a volatile memory, the copy from the memory 3 is not insured; in addition, the copy between the memories of the two MCUs is real-time, that is to say the delay is much smaller than the delay of copy from the memory 3, so the program file is preferably copied from the memory of the MCU 1 to the memory of the MCU 2.

If the processor 10 fails to copy the program file for updating from the memory 3 to the memory 12, for example, the MCU 1 is powered off during the copying process resulting in copy failure, or the memory 3 is powered off during the copying process resulting in the stored program file for updating in the memory 3 missing, the MCU 1 reports an update failure to the application module 211.

If the processor 10 fails to copy the program file for updating from the memory 12 to the memory 11 or the program cannot be run due to a file problem or the like after the copy is completed, the management module 212 switches from the MCU 1 to the MCU 2. Then, the processor 20 of the MCU 2 copies the program file currently being used by the management module 212 stored in the memory 21 to the memory 11 to restore the program file stored in the memory 11 before the update process is performed. In this way, after an MCU attempts to update but fails, another MCU restores its program version to the program version before updating, thus ensuring that both MCUs may operate normally. Thereafter, the update failure is reported to the application module 211 by the processor 10 or 20.

Operation 3: When the control module 210 or the management module 212 of the control module 210 is down, the self-service terminal 200 may self-restore.

In the case where the control module 210 is divided into the application module 211 and the management module 212, the management module 212 may include two processors. Preferably, the two processors respectively have respective memories to store respective program files and running data. The structure of the management module 212 may be referred to FIG. 3 but may be simpler than the structure shown therein. For example, the management module 212 may include an MCU 1 and an MCU 2, wherein the MCU 1 includes a processor 10 and a memory 11, and the MCU 2 includes a processor 20 and a memory 21. It will be appreciated that, in other embodiments, the management module 212 may have the structure shown in FIG. 3, i.e., the two processors each have two memories. It will be appreciated that the management module 212 may be implemented not by any MCU. In the case where the control module 210 is not divided into the application module 211 and the management module 212 but operates as a whole, the control module 210 includes two processors, each of which has a respective memory, that is, the control module 210 has a similar structure as the above management module 212 and therefore will not be described duplicated. The following describes the management module 212 as an example.

One of the two MCUs may operate as a primary MCU and the other may operate as a standby MCU. For example, when the MCU 1 is a primary MCU, the memory 11 is configured to store an active program file executed by the processor 10, while the MCU 2 is a standby MCU and the memory 21 is configured to store a standby program file executed by the processor 20, and vice versa. The active program file and the standby program file are identical. For example, after the operation similar to the above Operation 2 is performed, the program version of the active program file executed by the MCU 1 and the program version of the standby program file executed by the MCU 2 are identical, that is, the two MCUs execute the same function. In addition, the data stored in the memories between the two MCUs (such as the values of the registers, the temporarily stored/cached data, etc.) also need to be identical, for example, by real-time copying between the memory 11 and the memory 21, so that the operations may be continuous when a running MCU switches from one to the other. As such, the upper layer operating entity (e.g., the application module 211 or the control center 110) or the user may not be aware of the switching between the MCUs in management module 212.

The two MCUs can pre-agree on the rules for switching. For example, it may be pre-agreed to switch according to a time period, that is, in the first time period, the MCU 1 operates as the primary MCU and the MCU 2 operates as the standby MCU, and in the second time period, switching to the MCU 2 as the primary MCU and the MCU 1 as the standby MCU. It may also be pre-agreed that the MCU 1 operates as the primary MCU and the MCU 2 operates as the standby MCU by default, and when the MCU 1 is down (e.g., stops running due to abnormal conditions such as a software and/or hardware exception), it switches to MCU 2 as the primary MCU and the MCU 1 as the standby MCU. In either case, the service life of the management module 212 may be extended.

In some embodiments, when the MCU 1 operating as the primary MCU is running, the MCU 2 operating as the standby MCU periodically listens to (or “monitors”) the heartbeats of the MCU 1. If no heartbeat of the MCU 1 is received for a predetermined length of time, it is determined that the MCU 1 is down and the MCU 2 starts running at the time as the primary MCU. After the MCU 2 starts running, an attempt is made to restore the MCU 1 (for example, it can be done while the MCU 2 idle or through a process running at a lower priority). For example, it is possible to restart the MCU 1 by controlling the power supply to the MCU 1 to be powered off for a period of time and then powering on it back. It is also possible to flash the MCU 1 (for example, after restarting the MCU 1 still cannot restore the MCU 1), e.g., writing the standby program file executed by the processor 20 of the MCU 2 to the memory 11 of the MCU 1 that stores the active program file, so as to attempt to restore the MCU 1. As such, when the primary MCU in the two MCUs of the management module 212 fails to operate normally, the standby MCU may try to restore it by the above approach, which causes most abnormal situations (such as abnormal interruption of the program operation, destruction of the program file, etc.) to be handled by the management module 212 so as to restore normality by the self-service terminal 200 itself. Thus, the user of the self-service terminal 200 may not perceive the failure of the self-service terminal 200, and supervisors are not required to manually perform the operations such as restarting, flashing, and the like. This not only reduces the labor cost, but also allows services of the self-service terminal 200 to the user continuous.

In some cases, the MCU 1 cannot be restored by the above approach. After the MCU 2 fails to restore the MCU 1, the MCU 2 may report to the application module 211 that the MCU 1 is down. The application module 211 may push a warning message to a supervisor (e.g., a message being displayed on the screen of the self-service terminal 200, a warning being indicated by the indicator light of the self-service terminal 200, or a message being displayed on the electronic device of the supervisor, etc.), and/or may report the message to the control center 110 which will push a warning message to the supervisor so that the supervisor may maintain the self-service terminal 200 manually. It should be noted that during this maintenance, the MCU 2 is still running the standby program, that is, the self-service terminal 200 still provides services to the user normally, so that the user may not know that one of the MCUs in the self-service terminal 200 has failed. After the supervisor recover the MCU 1 by manual operation, the management module 212 may be switched to be operated by the MCU 1 as the primary MCU and the MCU 2 as the standby MCU; or the MCU 2 may still be operated as the primary MCU and the MCU 1 as the standby until the pre-agreed switching condition is met.

Operation 4: The self-service terminal 200 controls its own power on and power off without manual operation.

The self-service terminal disposed in, for example, a store only needs to be kept power on within business hours of the store, and to be kept power off within non-business hours to save power and extend the service life of the self-service terminal. If the switch on and off of the self-service terminal is operated manually, the labor cost is high. In addition, in some cases, the operators of the self-service terminal want to update the self-service terminal during non-business hours, for example a patch package for a program file that needs to be installed urgently before the next business hour. In this case, the supervisor may not be able to reach the site of the self-service terminal in time. If the self-service terminal may be powered on automatically after it has been powered off, the problem will be solved.

After the self-service terminal 200 is powered off, all devices included in the device module 220 may no longer operate. A portion of the control module 210, such as the application module 211, may either no longer operate. Another portion of the control module 210, such as the management module 212, may continue to operate after the self-service terminal 200 is powered off, for example, may operate in a low power mode. The management module 212 may control the power switch of the application module 211 and the device module 220. For example, the application module 211 controls the power switch to be turned on so as to control the application module 211 and the device module 220 to be powered on. The management module 212 may control the power switch to be turned off so as to control the application module 211 and the device module 220 to be powered off.

The control module 210 of the self-service terminal 200 may store a preset schedule that indicates when the self-service terminal 200 needs to be powered on and off for each day of year. For example, a self-service terminal disposed on a campus may be configured to be powered on at 7 am and to be powered off at 10 pm every day during the semester, but to be powered on at 9 am and to be powered off at 8 pm every day during the holidays. The schedule may be preset by the control center 110 to the self-service terminal 200. The schedule may be stored in the application module 211 or in the management module 212.

If the schedule is stored in the management module 212, the management module 212 may control the power on/off of the self-service terminal 200 according to the time and date of power on/off indicated by the schedule. The management module 212 may calibrate its local time and date by connecting to the Internet. If the schedule is stored in the application module 211, the application module 211 may inform the management module 212 of the time and date of the power on/off indicated by the schedule, and then the management module 212 may control the power on/off of the self-service terminal 200. For example, each time the self-service terminal 200 is powered on, the application module 211 may notify at least one power-off time and at least one power-on time in future (e.g., the most recent and next power-off time and power-on time) to the management module 212 based on the schedule.

The application module 211 and the management module 212 may have respective network cards, such as for example, 3G network cards, WIFI network cards, etc., so that the application module 211 and the management module 212 may respectively communicate with the control center 110, for example, via communication links L1 and L2 respectively, as shown in FIG. 2. The communication links L1 and L2 may be implemented by connecting the application module 211, the management module 212, and the control center 110 to the Internet, respectively. In the power-on state of the self-service terminal 200, communications between the self-service terminal 200 and the control center 110 is implemented through the communication link L1; in the power-off state of the self-service terminal 200, communications between the self-service terminal 200 and the control center 110 is implemented through the communication link L2.

The management module 212 is capable of receiving messages from the control center 110 over the communication link L2 after the self-service terminal 200 is powered off. If a message for indicating the self-service terminal 200 to be powered on is received, the management module 212 control the self-service terminal 200 to be powered on. In this way, for example in the case where there is a patch package of the program file for emergency installation need to be sent to the self-service terminal 200 after the self-service terminal 200 is powered off, the control center 110 may send a message to the management module 212 of the self-service terminal 200 to instruct a power-on operation, and the management module 212 controls the self-service terminal 200 to be powered on. And then the control center 110 may push the patch package of the program file that needs to be urgently installed to the self-service terminal 200.

Operation 5: The self-service terminal 200 reports its information to the control center 110, including operation results, configurations, status, attributes, heartbeats, and/or the like.

The management module 212 periodically queries the operation result, configuration, status, attributes, and/or heartbeat of each device in the device module 220, and sends the query result to the application module 211, and the application module 211 sends the query results to the control center 110. After the application module 211 receives the query result, the query results may be displayed on the screen of the self-service terminal 200. In addition, the application module 211 may report the query result to the control center 110. The control center 110 may display the information reported by the self-service terminal 200 on the screen of the control center 110 or store into a log file of the self-service terminal 200 stored in the control center 110. An exemplary scenario may be that the management module 212 periodically queries the temperature/humidity measured by the thermometer/hygrometer in the device module 220 and reports the measured temperature/humidity to the application module 211 and further to the control center 110.

It will be appreciated by those skilled in the art that the same or similar description is omitted in the above detailed description of each operation procedure for the sake of brevity. In the above description, the operations performed by the management module 212 and the application module 211, respectively, may be performed by the control module 210 as a whole. It will be appreciated by those skilled in the art that the above description of the application scenarios is merely exemplary and not exhaustive or limiting, and the technical solutions of the present disclosure may also be applied to other scenarios.

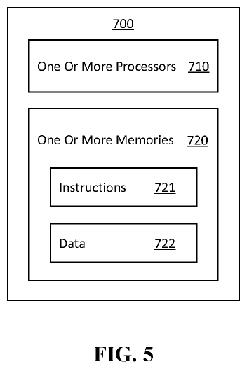

FIG. 5 is a block diagram schematically illustrating at least a portion of a self-service terminal 700 according to embodiments of the present disclosure. The at least a portion of the self-service terminal 700 may be, for example, one or more of the following: the control module 210, the application module 211, the management module 212, the MCU 1 of management module 212, the MCU 2 of management module 212, the device module 220, the devices 221 through 223, and the control center 110. The various functions described above, including the methods, operations, processes, steps, applications, procedures, etc. mentioned above, can be implemented in hardware, software, firmware, or any combination thereof. If implemented in software, the various functions may be implemented by one or more instructions 721 stored on a memory 720, such as a computer readable medium. If implemented in firmware, the various functions may be implemented by the processor 710 executing instructions 721, such as firmware code, stored on the memory 720. If implemented in hardware, various functions can be implemented by processing circuitry.

The at least a portion of the self-service terminal 700, the management module 212 for example, includes one or more processors 710 and one or more memories 720, wherein one or more processors 710 are communicably coupled to one or more memories 720. One or more of the one or more memories 720 can be coupled to one or more processors 710 via a bus, port, or network, and/or can be directly coupled or incorporated in any one of the one or more processors 710. Each of the one or more memories 720 can store content that is accessible by one or more processors 710, including instructions 721 that can be executed by one or more processors 710, and data 722 that can be retrieved, manipulated, or stored by one or more processors 710.

The instructions 721 may be any set of instructions to be executed directly, such as machine code, or indirectly, such as scripts, by the one or more processors 710. The instructions 721 may be stored in object code format for direct processing by the one or more processors 710, or in any other computing device language including scripts or collections of independent source code modules that are interpreted on demand or compiled in advance. Functions, methods and routines of the instructions 721 are explained in more detail above.

The one or more memories 720 may be any transitory or non-transitory computer readable storage medium capable of storing contents accessible by the one or more processors 710, such as a hard drive, a memory card, an ROM, an RAM, a DVD, a CD, a USB memory, a write-enabled memory, a read-only memory or the like. The one or more memories 720 may include a distributed storage system where the instructions 721 and/or the data 722 are stored on a plurality of different storage devices which may be physically located at the same or different geographic locations.

The one or more processors 710 may retrieve, store or modify the data 722 in accordance with the instructions 721. The data 722 stored in the one or more memories 720 may include received multiple frames mentioned above including various fields in the frames, received multiple frames for a segment transmission, frames to be transmitted, data (for example, a payment code read from the user) related to one or more operations of one or more devices, and the like. Those skilled in the art will appreciate that other data may also be stored in one or more memories 720. For example, although the subject matter described herein is not limited by any particular data structure, the data 722 may also be stored in computer registers (not shown) as a table or XML document having many different fields and records stored in a relationship database. The data 722 may also be formatted in any computing device-readable format such as, but not limited to, binary values, ASCII or Unicode. In addition, the data 722 may include any information sufficient to identify relevant information, such as a serial number, descriptive text, a dedicated code, a pointer, references to data stored in other memories such as at other network locations, or information used by a function for computing related data.

The one or more processors 710 may be any conventional processors, such as a commercially available central processing unit (CPU), graphics processing unit (GPU), microprogrammed control unit (MCU), and the like. Alternatively, one or more of the processors 710 may also be dedicated components such as an application specific integrated circuit (ASIC) or other hardware based processor. Although not required, one or more processors 710 may include specialized hardware components to perform particular computing processes, such as checking the frames, etc., faster or more efficiently.

Although one or more processors 710 and one or more memories 720 are shown schematically in the same block in FIG. 5, one or more processors 710 or one or more memories 720 may actually include processors or memories that may exist in the same physical housing or in different physical housings. For example, one of the one or more memories 720 can be a hard drive or other storage medium located in a different housing than the housing of each of the one or more processors 710. Accordingly, references to processor or memory should be understood to include a collection of processors or memories that refer to possible parallel operations or possibly non-parallel operations. Although some of the functions described above are indicated to occur on a single computing device having a single processor, various aspects of the subject matter described herein can be implemented by multiple processors 710, for example, in communication with one another via network.

Moreover, although one or more processors 710 and one or more memories 720 are schematically illustrated in different blocks in FIG. 5, the at least a part of a self-service terminal 700 can be formed as a component, such as the processors 710, the memories 720, and various peripheral interfaces (such as a USB interface, an A/D conversion interface, and a UART interface, etc.) are integrated into a single chip to form a single chip microcomputer.

Although some specific embodiments of the present disclosure have been described in detail with examples, it should be understood by a person skilled in the art that the above examples are only intended to be illustrative but not to limit the scope of the present disclosure. The embodiments disclosed herein can be combined arbitrarily with each other, without departing from the scope and spirit of the present disclosure. It should be understood by a person skilled in the art that the above embodiments can be modified without departing from the scope and spirit of the present disclosure. The scope of the present disclosure is defined by the attached claims.

What is claimed is:

1. A self-service terminal comprising:
one or more devices;
an application module configured to provide an application to a user; and
a management module configured to manage the one or more devices, wherein
the application module is further configured to: compare a target file for at least one device of the one or more devices to update with a current file that is being used by the at least one device, determine if the current file is different from the target file, and send the target file to the management module in response to that it is determined that the current file is different from the target file, wherein the target file comprises a configuration file or a program file that is capable of being used by the at least one device;
the management module is further configured to: receive the target file from the application module, and send the target file to the at least one device; and
the at least one device is configured to: receive the target file and update the current file to the target file.

2. The self-service terminal according to claim 1, wherein
the application module is further configured to: acquire a version identification of the target file, query the management module for a version identification of the current file, compare the two version identifications, and determine that the current file is different from the target file in response to the two version identifications being different; and
the management module is further configured to: acquire the version identification of the current file and report it to the application module by at least one of:
querying the at least one device for the version identification of the current file; or
reading the version identification of the current file from a log file.

3. The self-service terminal according to claim 2, wherein the application module is further configured to acquire the version identification of the target file according to at least one of:
a file name of the target file;
a specific portion of the target file; and
a received message that is associated with the target file.

4. The self-service terminal according to claim 1, wherein the application module is further configured to: determine, before the comparing, the at least one device that the target file is for according to at least one of:
a storage path of the target file;
a file name of the target file;
a specific portion of the target file; and
a received message that is associated with the target file.

5. The self-service terminal according to claim 1, wherein the application module is further configured to: acquire, before the sending, the target file by at least one of:
looking up a plurality of specific storage paths;
accessing a storage path specified by a received message that is associated with the target file; and
receiving one or more messages that are associated with the target file.

6. The self-service terminal according to claim 2, wherein the application module is further configured to: before the comparing,
acquire, by looking up a plurality of specific storage paths, the target file from at least one storage path corresponding to the at least one device, and determining the at least one device according to the at least one storage path; and
acquire the version identification of the target file according to a file name of the target file.

7. The self-service terminal according to claim 1, wherein
the application module is further configured to: verify the target file according to a first verification information of the target file, and send the target file to the management module in response to the target file being verified successfully;
the management module is further configured to: verify the target file according to a second verification information of the target file, and send the target file to the at least one device in response to the target file being verified successfully; and/or
the at least one device is further configured to: verify the target file according to a third verification information of the target file, and update the current file to the target file in response to the target file being verified successfully.

8. The self-service terminal according to claim 1, wherein the application module is further configured to perform the comparing:
after the self-service terminal is powered on;
when the self-service terminal is idle; and/or
after receiving a message for indicating the self-service terminal to process the target file.

9. The self-service terminal according to claim 1, wherein
the application module is further configured to: receive a first configuration command for configuring at least one device of the one or more devices, and send the first configuration command to the management module;
the management module is further configured to: transform the first configuration command into a second configuration command having a format that is recognizable by the at least one device, and send the second configuration command to the at least one device; and
the at least one device is further configured to: receive the second configuration command and update a corresponding configuration of the at least one device to a configuration that is indicated by the second configuration command.

10. The self-service terminal according to claim 1, wherein the management module is further configured to control the self-service terminal to be powered on and/or powered off by controlling on/off of a power supply of the self-service terminal.

11. The self-service terminal according to claim 10, wherein
the application module and the one or more devices are further configured to: stop running after the self-service terminal is powered off; and
the management module is further configured to: keep running after the self-service terminal is powered off so as to receive a message from an entity other than the self-service terminal.

12. The self-service terminal according to claim 11, wherein the management module is further configured to: after the self-service terminal is powered off, control the self-service terminal to be powered on in response to a message for indicating the self-service terminal to be powered on from the entity being received.

13. The self-service terminal according to claim 10, wherein
the application module is further configured to: store a preset schedule, and notify, according to the schedule, the management module of at least one power-on time and at least one power-off time in future; and
the management module is further configured to: control the self-service terminal to be powered on and/or powered off according to the at least one power-on time and the at least one power-off time, respectively.

14. The self-service terminal according to claim 1, wherein
the management module is further configured to: periodically query the one or more devices for operation results, configurations, status, and/or heartbeats of respective devices, and send query results to the application module; and
the application module is further configured to: receive the query results from the management module, and display the query results on the self-service terminal and/or notify the query results to an entity other than the self-service terminal.

15. The self-service terminal according to claim 1, wherein
the application module is further configured to: receive a first program file for the management module to update, compare the first program file with a second program file that is being used by the management module, and send the first program file to the management module in response to the first program file being different from the second program file;
the management module is further configured to: receive the first program file from the application module, and update the second program file to the first program file.

16. The self-service terminal according to claim 15, wherein the management module comprises first through fifth memories and first and second processors, wherein the first and second memories respectively store the second program file and a copy thereof that are executable by the first and second processors, respectively, the fourth and fifth memories are respectively used by the first and second processors, and the management module is further configured to:
store the first program file that is received from the application module in the third memory;
copy, by the first processor, the first program file from the third memory to the fourth memory;
in response to the copying the first program file from the third memory to the fourth memory being successful, copy, by the first processor, the first program file from the fourth memory to the first memory so as to update the second program file in the first memory to the first program file, and
in response to the updating being successful, copy, by the first processor, the first program file from the first or fourth memory to the second memory so as to update the second program file in the second memory to the first program file; and
in response to the updating being unsuccessful, copy, by the second processor, the second program file in the second memory to the first memory so as to restore the second program file in the first memory, and report, by the first or second processor, an update failure to the application module; and
in response to the copying the first program file from the third memory to the fourth memory being unsuccessful, report, by the first processor, an update failure to the application module.

17. The self-service terminal according to claim 16, wherein the first, second, fourth and fifth memories are non-volatile memories and the third memory is a volatile memory.

18. The self-service terminal according to claim 1, wherein the management module comprises first and second processors, wherein the second processor is configured to:
be standby when the first processor is running, and periodically monitor heartbeats of the first processor;
determine that the first processor is down in response to no heartbeat of the first processor being received by the second processor for a predetermined length of time; and
start running in response to that it is determined that the first processor is down.

19. The self-service terminal according to claim 18, wherein the second processor is further configured to:
attempt to restore the first processor after the second processor starts running; and
report to the application module that the first processor is down in response to the attempting to restore being unsuccessful.

20. The self-service terminal according to claim 19, wherein the attempting to restore comprises at least one of:
turn off and then turn on power supply to the first processor so as to restart the first processor;
copy a program file that is being executed by the second processor to a memory for storing a program file of the first processor so as to restore the program file of the first processor.
